(19) United States
(12) Patent Application Publication
(10) Pub. No.: US 2020/0244184 A1
(43) Pub. Date: Jul. 30, 2020

(54) CONTROL OF DELTA-CONNECTED CONVERTER

(71) Applicant: ABB Schweiz AG, Baden (CH)

(72) Inventor: Andreas Voegeli, Bad Zurzach (CH)

(21) Appl. No.: 16/850,345

(22) Filed: Apr. 16, 2020

Related U.S. Application Data
(63) Continuation of application No. PCT/EP2018/079028, filed on Oct. 23, 2018.

(30) Foreign Application Priority Data
Oct. 27, 2017 (EP) 17198883.5

(51) Int. Cl. H02M 7/49; H02M 1/12; H02P 27/14; H02M 5/458

(52) U.S. Cl. CPC H02M 7/49; H02M 5/458; H02P 27/14; H02M 1/12

(57) ABSTRACT

An electrical converter includes three branches of series-connected converter cells, each converter cell including a rectifier, a DC link with a DC link capacitor and an inverter, the three branches are delta-connected at phase outputs of the electrical converter. In the method for controlling the electrical converter, the converter cells are controlled to generate three AC phase output currents at the phase outputs and a circulating current through the branches.

### FIELD OF THE INVENTION

The invention relates to a delta-connected converter and to a method for controlling a converter.

### BACKGROUND OF THE INVENTION

Cascaded H-bridge converters are used for driving electrical machines with high voltages and high currents. Such converters comprise several branches, in which H-bridges are series-connected at their outputs to produce a high output voltage. The H-bridges may be supplied via DC links and rectifiers, which, for example, are supplied by an electrical grid. One possibility is to star-connect three such branches for generating a three-phase output current.

A usual approach to increase the current ratings of such a converter is to use power semiconductors with higher current ratings. However, this may increase costs substantially.

WO 2016 198 370 A1 shows s modular multilevel converter with groups of series connected H-bridges. It is proposed that the groups may be delta-connected.

GB 2 511 358 A shows a converter with three star-connected branches, each of which is composed of series-connected converter cells. The converter cells are supplied by a multi-winding transformer. In the beginning, it is mentioned that unwanted harmonics may generate circulating currents.

### DESCRIPTION OF THE INVENTION

It is an objective of the invention to provide an economical electrical converter based on series-connected converter cells, which has a high current rating.

This objective is achieved by the subject-matter of the independent claims. Further exemplary embodiments are evident from the dependent claims and the following description.

A first aspect of the invention relates to a method for controlling an electrical converter. For example, the converter may be used for supplying an electrical motor with electrical energy from an electrical grid. The converter may be a power converter adapted for processing currents of more than 100 A and/or more than 1 kV, such as 3.3 kV, 4.16 kV and 6 kV.

According to an embodiment of the invention, the electrical converter comprises three branches of series-connected converter cells, each converter cell comprising a rectifier, a DC link with a DC link capacitor and an inverter, wherein the three branches are delta-connected at phase outputs of the electrical converter. The inverters may be connected in series at their outputs to generate a branch voltage that is a multiple of the output voltage of the converter cells. The phase outputs may be connected with an electrical machine, such as an electrical motor, which is supplied by the electrical converter. The rectifiers may be connected via a transformer to an AC voltage source, for example an electrical grid.

With branches that are delta-connected with each other, the current rating of the output currents already may be \sqrt{3}≈173% times higher than with star-connected branches. Furthermore, in delta-connected branches it is possible to inject a circulating current without affecting the phase output currents. This may be achieved with a suitable control method.

The method may be performed by a controller of the electrical converter, which may collect current and/or voltage measurements from the electrical converter and which may control the electrical converter based on reference parameters, such as a demanded torque and/or speed of the electrical motor supplied by the electrical converter.

According to an embodiment of the invention, the converter cells are controlled to generate three AC phase output currents at the phase outputs and a circulating current through the branches. In particular, the circulating current may be controlled to be different from 0. For example, the circulating current may be at least 0.05 of magnitude of the phase output currents.

The circulating current may be used for semiconductor peak current reduction in order to increase current ratings and/or to reduce a DC link capacitor ripple current in order to increase the lifetime of the DC capacitors.

In particular, the circulating current is controlled to comprise a third harmonic of branch currents through the branches. Furthermore, the circulating current is controlled such that minima of the third harmonic of the circulating current are located at maxima of a fundamental frequency of the branch currents through the branches and/or that maxima of the third harmonic of the circulating current are located at minima of the fundamental frequency of the branch currents through the branches.

For example, the circulating current may be purely a third harmonic of the fundamental frequency of the branch currents. It may be that only the magnitude and/or the phase angle of the circulating current is controlled. It also may be that the magnitude and/or the phase angle is set to a fixed value with respect to the corresponding values of the branch currents.

A third harmonic may have no impact on the phase output currents, may decrease the peak current through the converter branches, and/or may decrease the DC link current ripples. A phase output current may be the difference between the two corresponding branch currents.

For example, controlling the circulating current to be solely a third harmonic of the fundamental frequency of the branch currents may lead to peak current shaving and thus may increase the margins towards the safe operation area of the semiconductors.

A second effect of the circulating current being a third harmonic may be that the capacitor ripple current in the converter cells is reduced. It is a known phenomenon in electrical converters based on series-connected converter cells that there may be a large power pulsation with twice the fundamental frequency in the DC link. This may lead to a dominant ripple current with a frequency twice as high the fundamental frequency. As will be shown below, a third harmonic current in the delta-connected branches also may lead to a second harmonic in the capacitor ripple current with opposite sign. This effect may be used for ripple current reduction. Furthermore, a decreased second harmonic in the DC link ripple current may allow a lower output frequency towards an electrical machine connected to the electrical converter.

It may be that the maxima and minima of the circulating current and the fundamental frequency of the branch currents are not located directly at the same angle, but may be shifted slightly with respect to each other.

According to an embodiment of the invention, the circulating current is controlled such that a power output at the phase outputs is increased. For example, this may be done in a way that a peak current of a current through each branch is decreased by deviating from a sinusoidal branch current.

According to an embodiment of the invention, the circulating is controlled such that low harmonics of a current through the DC link capacitors arc reduced. The capacitor ripple current in a power module is reduced. As will be described below in detail, a circulating current induced in the branches has an influence on the harmonics of the current through the DC link capacitors. In particular, it is possible with a circulating current to reduce the magnitude of low order harmonics of the DC link current. As the capacitor lifetime is reduced stronger by lower order harmonics as higher order harmonics, this may increase the lifetime of the DC link capacitors. Furthermore, a reduction in the DC link ripple current may result in a reduced DC link ripple voltage and therefore may result in reduced higher order harmonics in the electrical grid.

Low order harmonics may be harmonics of order 2 and/or 3. It has to be noted that an n.th harmonic is a frequency component of the respective current, which has the n times frequency of the fundamental frequency component of the current.

According to an embodiment of the invention, the circulating is controlled such that a second harmonic of a current through the DC link capacitors is reduced. This harmonic may have the strongest influence on the capacitor lifetime.

The one or more control objectives as described above may be achieved with a controller that actively optimizes these control objectives. For example, the controller may receive one or more reference parameters for the output currents and/or an output voltage, such as a reference frequency, a reference torque, a reference speed, etc. The controller then may generate reference voltages for the phase outputs and/or the converter cells, which optimize the control objectives, for the desired reference parameters. These references then may be translated into switching commands for the converter cells, for example by pulse-width modulating.

Such a controller may be based on model predictive control, in which one or more objective functions may be optimized to achieve the control objectives mentioned above and below.

For example, the reference voltages may be generated with model predictive control and/or by optimizing a cost function, in which the one or more control objectives are encoded.

The control objectives as described above also may be achieved by controlling a circulating current with specific preselected properties. The shape or form of the circulating current may be fixed. For example, it may be or may comprise the third harmonic of the output currents.

According to an embodiment of the invention, a phase angle of the third harmonic of the circulating current is set, such that extrema of a fundamental frequency of the branch currents are reduced. As mentioned above, the phase angle of the circulating current may be controlled, such that the third harmonic of the circulating current are located at maxima of a fundamental frequency of each branch current and vice versa.

According to an embodiment of the invention, a magnitude of the third harmonic of the circulating is between 0.1 and 0.2 of the magnitude of a fundamental frequency of the branch currents. The highest phase output currents may be achieved with a relative magnitude of about 1.15 for the third harmonic. In the best case, the phase output current may be 173%×1.15%=200% higher compared to a star-connected converter having the same current ratings for its power semiconductors.

In summary, combining a delta-connected topology with a third harmonic current, twice the phase output current may be achieved compared to a star-connected topology without changing any converter cell ratings. However, as the branch voltages may need to be higher in a delta-connection, more converter cells per branch may be needed compared to star-connected branches.

According to an embodiment of the invention, the phase output currents are phase-shifted by 120° with respect to each other. It may be that the phase output currents are controlled to be sinusoidal.

A further aspect of the invention relates to the electrical converter, as described in the above and in the following, which comprises a controller for controlling the converter cells according to the method as described in the above and in the following. It has to be understood that features of the method as described in the above and in the following may be features of the converter as described in the above and in the following, and vice versa. The controller may comprise a processor for executing software and the method may be implemented at least partially in software. The controller also may comprise a DSP and/or an FPGA and the method may be implemented at least partially in hardware.

According to an embodiment of the invention, the rectifiers are passive rectifiers. The rectifiers may be composed of one or more half-bridges, which are based on diodes.

According to an embodiment of the invention, the inverters are H-bridge inverters. Every inverter may comprise two-half-bridges, each of which is composed of two semiconductor switches, such as transistors or thyristors.

According to an embodiment of the invention, the converter further comprises a transformer with a three-phase primary side and with a multi-phase secondary side providing a separate input current for each rectifier. The primary side may be connected to an electrical grid. The secondary side may comprise a plurality of secondary windings, which are galvanically separated from each other. Furthermore, it may be that each rectifier is provided with three 120° phase-shifted input currents.

According to an embodiment of the invention, the secondary side of the transformer is designed, such that input currents of the rectifiers are phase-shifted with respect to each other. For example, the secondary windings of the transformer may be designed, such that they provide m differently phase-shifted output currents, which are phase-shifted by 60°/m with each other. For example, the number m may be 2, 3 or more. Such phase shifts of the converter cells may reduce higher order harmonics produced by the converter that may be injected into the electrical grid.

These and other aspects of the invention will be apparent from and elucidated with reference to the embodiments described hereinafter.

### BRIEF DESCRIPTION OF THE DRAWINGS

The subject-matter of the invention will be explained in more detail in the following text with reference to exemplary embodiments which are illustrated in the attached drawings.

FIG. 1 schematically shows an electrical converter according to an embodiment of the invention.

FIG. 2 schematically shows a converter cell for the converter of FIG. 1.

FIG. 3 shows a diagram illustrating current flows in the converter of FIG. 1.

FIGS. 4 and 5 show diagrams with currents in the converter of FIG. 1.

FIG. 6 shows a flow diagram for a method for controlling the converter of FIG. 1.

The reference symbols used in the drawings, and their meanings, are listed in summary form in the list of reference symbols. In principle, identical parts are provided with the same reference symbols in the figures.

### DETAILED DESCRIPTION OF EXEMPLARY EMBODIMENTS

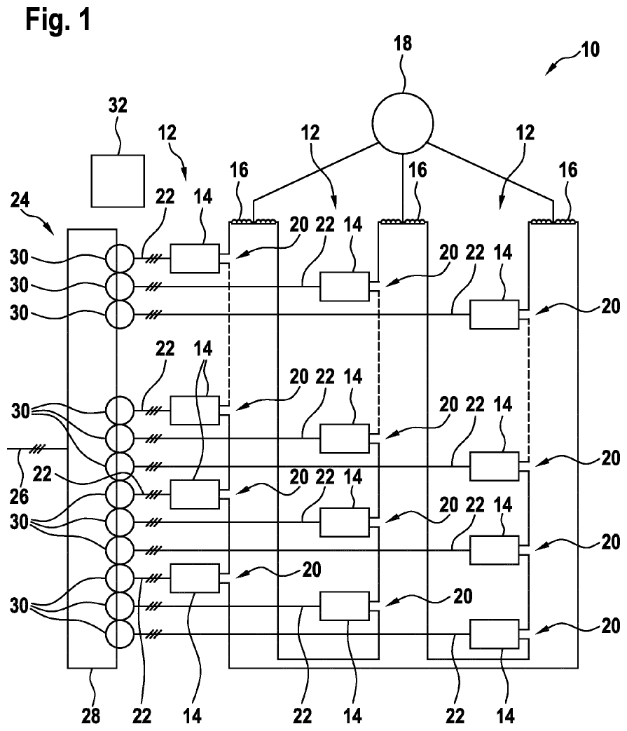

FIG. 1 shows an electrical converter 10, which comprises three branches 12 of series-connected converter cells 14. The branches 12 are delta-connected via inductors 16. Every conductor has a midpoint at which a phase output A, B, C of the electrical converter 10 is provided.

The converter 10 is adapted for generating a three-phase output current at the phase outputs A, B, C, which may be supplied to an electrical motor 18.

The branches 12 may comprise the same number of converter cells 14. The converter cells 14 are series-connected at their outputs 20 for forming the branches 12. At their inputs 22, the converter cells 14 are connected to a transformer 24, which is adapted for transforming a three-phase input voltage from an electrical grid 26 into three-phase input voltages to be supplied to the inputs 22 of the converter cells.

The transformer 24 may have a primary winding 28 for each phase of the input voltage from the grid 26 and a secondary winding 30 for each phase of the input voltage of the converter cells 14. Thus, for each converter cell 14, a group of 4 secondary windings 30 may be present. Groups of secondary windings 30 may be phase-shifted with respect to each other for reducing harmonics produced by the converter 10 at its input side.

Furthermore, FIG. 1 shows a controller 32 for controlling the converter cells 14.

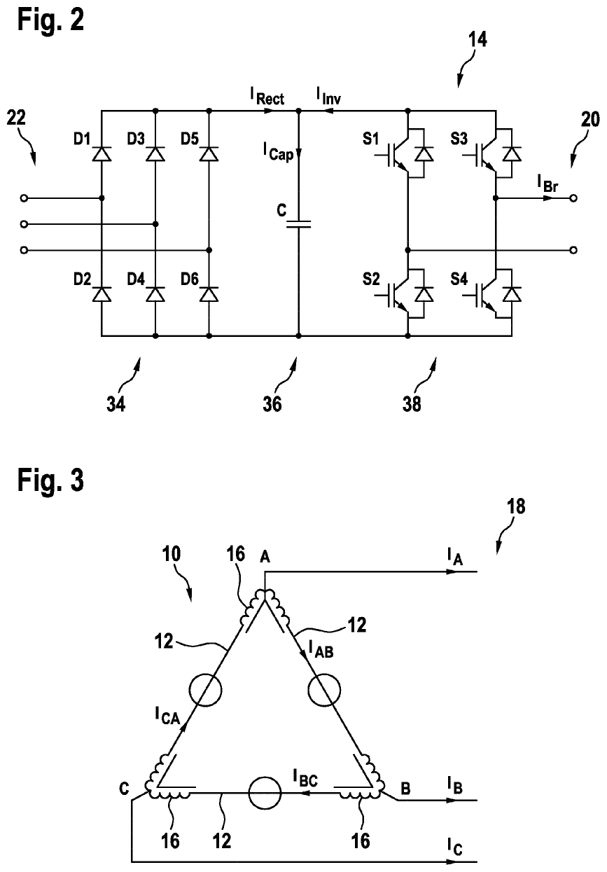

FIG. 2 shows one of the converter cells 14 in more detail. The converter cell 14 comprises a rectifier 34, a DC link 36 and an inverter 38, which are cascade-connected between the input 22 and the output 20.

The rectifier 34 may be a passive rectifier. For each input phase, the rectifier 34 may comprise a half-bridge composed of two diodes D1, D2, D3, D4, D5, D6.

The inverter 38 comprises two half-bridges composed of two semiconductor switches S1, S2, S3, S4, which provide the two output phases of the output 20. The semiconductor switches S1, S2, S3, S4 are controlled by the controller 32. Each semiconductor switch S1, S2, S3, S4 may comprise an IGBT, or other controllable semiconductor device, with an anti-parallel connected freewheeling diode.

The DC link 36 comprises a DC link capacitor C, which is connected in parallel to the half-bridges of the rectifier 34 and the inverter 38.

FIG. 3 shows a diagram illustrating currents through the converter 10. Phase output currents I_{A}, I_{B} and I_{C} are leaving the converter at the phase outputs A, B and C and flow through the electrical motor 18. The phase output currents I_{A}, I_{B} and I_{C} should sum up to 0. Through the branches 12 flow branch currents I_{AB}, I_{BC} and I_{CA} between the phase outputs A, B and C. Since the phase output current, such as I_{A}, is the difference of the corresponding branch currents, such as I_{CA} and I_{AB}, in a delta-connection there is a further degree of freedom. The sum of the branch currents I_{AB}, I_{BC} and I_{CA} need not be 0 and a circulating current flowing through the delta-connection may be present.

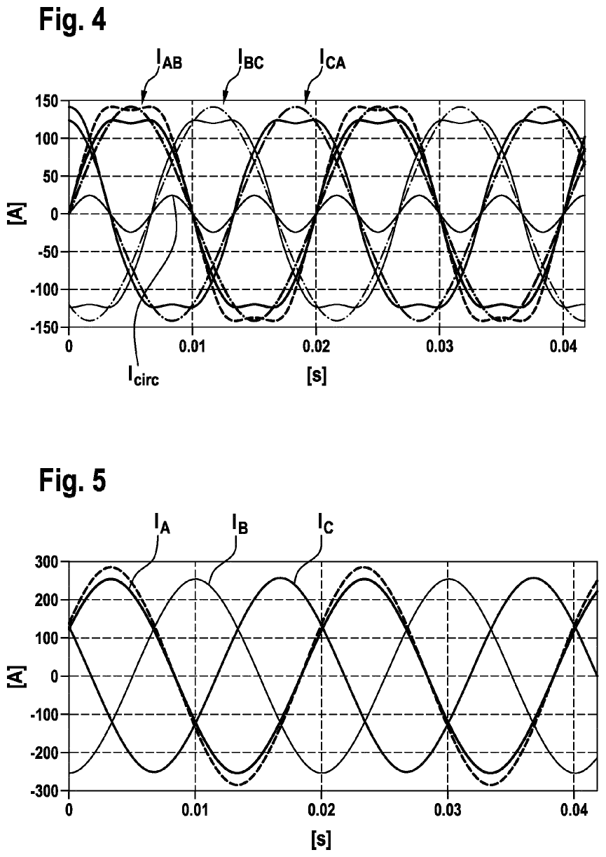

FIGS. 3 and 4 show examples of phase output currents I_{A}, I_{B} and I_{C} and branch currents I_{AB}, I_{BC} and I_{CA} together with the circulating current I_{circ}. As shown in FIG. 5, the phase output currents I_{A}, I_{B} and I_{C} are sinusoidal and phase-shifted by 120° with each other. As shown in FIG. 4, also the branch currents I_{AB}, I_{BC} and I_{CA} are phase-shifted by 120° with each other. However, a circulating current I_{circ} is chosen, such that the maxima of the branch currents I_{AB}, I_{BC} and I_{CA} are dented.

As shown in FIG. 3, the branch currents I_{AB}, I_{BC} and I_{CA} may be a sum of sinusoidal current (depicted with a dotted line) with the fundamental frequency and a circulating I_{circ} being a third harmonic of the fundamental frequency. The phase and the magnitude of the circulating current I_{circ} is set, such that the branch currents I_{AB}, I_{BC} and I_{CA} (depicted with a solid line) have reduced maxima. In such a way, the branch currents may be scaled to higher values, while the maximal current stays below the current rating of the semiconductor switches, such as S1 to S4, of the converter 10. This is shown with the dashed line in FIG. 4. In FIG. 5, the corresponding scaled phase output current is also shown with a dashed line.

In general, the phase angle of a third harmonic of the circulating current I_{circ} may be set, such that extrema of a fundamental frequency of the branch currents I_{AB}, I_{BC}, I_{CA} is reduced.

This may be achieved by positioning the minima of the third harmonic of the circulating current I_{circ} at maxima of a fundamental frequency of the branch currents I_{AB}, I_{BC}, I_{CA} and vice versa.

The magnitude of the third harmonic of the circulating current I_{circ} may be chosen to be between 0.1 and 0.2 of the magnitude of the fundamental frequency of the branch currents I_{AB}, I_{BC}, I_{CA}. The highest power output may be achieved with a value of about 0.15 as described above.

Returning to FIG. 2, also a capacitor ripple current I_{Cap} may be reduced with a circulating current I_{circ} having third harmonic. The capacitor ripple current I_{Cap} is the sum of the rectifier current I_{Rect} and the inverter current I_{Inv} as shown in FIG. 2. Furthermore, the inverter current may be determined in the following way:

I_{cap}=I_{rect}+Iᵢₙᵥ

Iᵢₙᵥ=I_{br}·m·sin(ωt)

Where m is the modulation index and I_{Br} is the branch current, i.e. one of I_{AB}, I_{BC}, I_{CA}. The last equation is due to the structure of the inverter 38.

The branch current I_{Br} including a third harmonic frequency 3ω of the fundamental frequency ω may be expressed as follows:

I_{br}=Î_{br}·[sin(ωt+φ)+A·sin(3ωt+δ)]

where Î_{br} is the overall magnitude of the branch current and A is the relative magnitude of the third harmonic. Iᵢₙᵥ thus can be rewritten:

Iᵢₙᵥ=m·sin(ωt)·Î_{br}·[sin(ωt+φ)+A·sin(3ωt+δ)]

Using the trigonometric identity sin(x1)·sin(x2)=½[cos(x1−x2)−cos(x1+x2)] leads to the following expression:

$${I}_{inv} = \frac{m \cdot {\hat{I}}_{br}}{2} \cdot [ \underbrace{cos ( ϕ )}_{D C} \underbrace{- cos ( 2 ω t + ϕ ) + A \cdot cos ( 2 ω t + δ )}_{2 nd harmonic} \underbrace{- A \cdot cos ( 4 ω t + δ )}_{4 th harmonic} ]$$

The part with the second harmonic, which is due to the third harmonic branch current, may be utilized for reducing the ripple current I_{Cap} by selecting a suitable relative magnitude A and by selecting δ=φ. An increasing amplitude A may lead to second harmonic reduction in the ripple current I_{Cap}, but at the same time may also increase the fourth harmonic. However, as the capacitor wear is stronger for the second harmonic as for the fourth harmonic, the overall wear of the capacitors C may be reduced. Simulations have shown that a value of A=0.5 would result in a minimal root mean square ripple current. However, for increasing the power output, a value between 0.1 and 0.2 may be more beneficial.

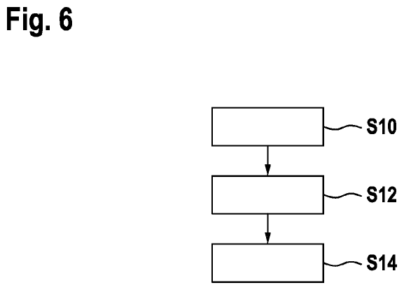

FIG. 6 shows a flow diagram for a method for controlling the converter 10. The method may be performed by the controller 32.

In step 10, the controller may receive control parameters for the system comprising the converter 10 and the electrical motor 18. Such control parameters may be a torque of the motor, a speed of the motor, etc. It also may be that the frequency of the phase output currents I_{AB}, I_{BC}, I_{CA} and/or their magnitude are such control parameters.

Furthermore, in step S10, the controller may receive measurement parameters of voltages and/or currents in the converter 10.

In step S12, the controller determines voltage references for the converter cell voltages output by the converter cells 14. The voltage references may be determined based on the control parameters and/or measurement values.

In the determination of the voltage references, the degrees of freedom offered by the circulating current I_{circ} are considered.

In an embodiment, the circulating current I_{circ} is controlled to comprise or to be a third harmonic of the branch currents I_{AB}, I_{BC}, I_{CA}, which has a phase shift with respect to the fundamental frequency and a relative magnitude as described above. In such a way, the output power is automatically increased and/or the capacitor ripple current is automatically reduced as described above.

However, the circulating current I_{circ} need not be controlled directly to comprise or be a third harmonic of the fundamental frequency. It also may be possible to control other control objectives that have influence on the circulating current. For example, the circulating current I_{circ} may be controlled such that a power output at the phase outputs A, B, C is increased and/or such that low harmonics of a current I_{Cap} through the DC link capacitors C are reduced. Due to the considerations above, however, also such control methods may result in a circulating current I_{circ} having a large third harmonic component.

For example, model predictive control and/or optimization of a cost and/or objective function may be performed to achieve the control objectives.

For example, the controller may be based on model predictive control. The measurement parameters may be input into a set of equations, which may comprise one or more of the equations above and/or equations modelling the converter shown in FIG. 1 and/or the branches 12. In particular, the model predictive control scheme may comprise an equation, which models the circulating current I_{circ}.

The model predictive control scheme may comprise an objective function, which is optimized during control, for example to achieve the desired phase angle and/or phase shift. It also may be that the objective function is modelled such that minima of the third harmonic of the circulating current I_{circ} are located at maxima of a fundamental frequency of the branch currents. The optimization may be performed with a quadratic program executed in the controller.

It may be that the phase shift and/or the magnitude of the circulating current are controlled to achieve these control objectives.

In step S14, switching signals for the converter cells are generated based on the voltage references. This may be done via pulse width modulation. The switching signals are then applied to the semiconductor switches, such as S1 to S4, of the converter cells 14.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

### LIST OF REFERENCE SYMBOLS

10 electrical converter

12 branch

14 converter cell

16 inductor

A, B, C phase output

18 electrical motor

20 output of converter cell

22 input of converter cell

24 transformer

26 electrical grid

28 primary winding

30 secondary winding

32 controller

34 rectifier

36 DC link

38 inverter

D1-D6 diodes of rectifier

S1-S4 semiconductor switches of inverter

C DC link capacitor

I_{Rect} rectifier current

I_{Inv} inverter current

I_{Cap} capacitor current

I_{Br} branch current

I_{A} phase output current

I_{B} phase output current

I_{C} phase output current

I_{AB} branch current

I_{BC} branch current

I_{CA} branch current

I_{circ} circulating current

1. A method for controlling an electrical converter, the electrical converter comprising three branches of series-connected converter cells, each converter cell comprising a rectifier, a DC link with a DC link capacitor and an inverter, wherein the three branches are delta-connected at phase outputs of the electrical converter and wherein the electrical converter comprises a transformer with a three-phase primary side and with a multi-phase secondary side providing a separate input current for each rectifier, the method comprising:
controlling the converter cells to generate three AC phase output currents at the phase outputs and a circulating current through the delta-connected branches; and
controlling the circulating current to comprise a third harmonic of branch currents through the branches, such that minima of the third harmonic of the circulating current are located at maxima of a fundamental frequency of the branch currents through the branches.

2. The method of claim 1, wherein the circulating current is controlled such that a power output at the phase outputs is increased.

3. The method of claim 2, wherein the circulating is controlled such that low harmonics of a current through the DC link capacitors are reduced.

4. The method of claim 3, wherein the circulating is controlled such that a second harmonic of a current through the DC link capacitors is reduced.

5. The method of claim 4, wherein a phase angle of a third harmonic of the circulating current is set, such that extrema of a fundamental frequency of branch currents through the branches are reduced.

6. The method of claim 5, wherein a magnitude of the third harmonic of the circulating current is between 0.1 and 0.2 of the magnitude of a fundamental frequency of branch currents through the branches.

7. The method of claim 6, wherein the phase output currents are phase-shifted by 120° with respect to each other.

8. An electrical converter, comprising:
three branches of series-connected converter cells;
wherein each converter cell comprises a rectifier, a DC link with a DC link capacitor and an inverter;
wherein the three branches are delta-connected at phase outputs of the electrical converter;
wherein the electrical converter comprises a transformer with a three-phase primary side and with a multi-phase secondary side providing a separate input current for each rectifier; and
a controller configured to control the converter cells to generate three AC phase output currents at the phase outputs and a circulating current through the delta-connected branches, the controller is further configured to control the circulating current to comprise a third harmonic of branch currents through the branches, such that minima of the third harmonic of the circulating current are located at maxima of a fundamental frequency of the branch currents through the branches.

9. The converter of claim 8, wherein the rectifiers are passive rectifiers.

10. The converter of claim 9, wherein the inverters are H-bridge inverters.

11. (canceled)

12. The converter of claim 10, wherein the secondary side of the transformer is designed, such that input currents of the rectifiers are phase-shifted with respect to each other.

13. The converter of claim 8, wherein the inverters are H-bridge inverters.

14. The method of claim 2, wherein the circulating is controlled such that low harmonics of a current through the DC link capacitors are reduced.

15. The method of claim 14, wherein the circulating is controlled such that a second harmonic of a current through the DC link capacitors is reduced.

16. The method of claim 1, wherein the circulating is controlled such that a second harmonic of a current through the DC link capacitors is reduced.

17. The method of claim 15, wherein a phase angle of a third harmonic of the circulating current is set, such that extrema of a fundamental frequency of branch currents through the branches are reduced.

18. The method of claim 1, wherein a phase angle of a third harmonic of the circulating current is set, such that extrema of a fundamental frequency of branch currents through the branches are reduced.

19. The method of claim 17, wherein a magnitude of the third harmonic of the circulating current is between 0.1 and 0.2 of the magnitude of a fundamental frequency of branch currents through the branches.

20. The method of claim 1, wherein a magnitude of the third harmonic of the circulating current is between 0.1 and 0.2 of the magnitude of a fundamental frequency of branch currents through the branches.

21. The method of claim 1, wherein the phase output currents are phase-shifted by 120° with respect to each other.
